(19) United States
(12) Patent Application Publication
(10) Pub. No.: US 2004/0105455 A1
(43) Pub. Date: Jun. 3, 2004

(54) Automatic edge port and one way connectivity detection with rapid reconfiguration for shared media in spanning tree configured bridged Local Area Networks

(76) Inventor: Michael John Seaman, Belvedere, CA (US)

Correspondence Address: MICHAEL JOHN SEAMAN, 160 BELLA VISTA AVE., BELVEDERE, CA, 94920-2466, US

(21) Appl. No.: 10/652,951

(22) Filed: Aug. 28, 2003

Related U.S. Application Data
(60) Provisional application No. 60/407,055, filed on Aug. 29, 2002.

(51) Int. Cl. H04L 12/28; H04L 12/56

(52) U.S. Cl. 370/423

(57) ABSTRACT

An improvement to the protocols used communication devices in data networks that require loop-free forwarding of data frames provides for rapid use of shared media links after changes in physical connectivity, for rapidly detecting the edge of the network so as to reduce interruptions of service by mechanisms that protect against loops, for preventing loops caused by one way connectivity, such as can occur if transmitter or receivers are broken or poorly connected to links, and for preventing loops caused by loop back. The improvement is applicable to the Bridged Local Area Networks and the spanning tree protocols specified in IEEE Standards 802.1D and 802.1Q and their amendments and revisions.

### CROSS-REFERENCE TO RELATED APPLICATIONS

The present application claims the benefit under 35 U.S.C. § 111(b) and 35 U.S.C. §119(e) of the provisional application No. 60/407,055, filed 29 Aug. 2003, entitled AUTOMATIC EDGE PORT AND ONE WAY CONNECTIVITY DETECTION WITH RAPID RECONFIGURATION FOR SHARED MEDIA IN SPANNING TREE CONFIGURED BRIDGED LOCAL AREA NETWORKS, naming inventor Michael John Seaman.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to network protocols and network intermediate devices executing such protocols; and more particularly to algorithms for selecting paths through a network by computing one or more spanning trees.

Local Area Networks (LANS) specified by Institute of Electrical and Electronic Engineers (IEEE) Standards for Metropolitan Area Networks may be connected together with media access control (MAC) bridges. Bridges interconnect LANs so that stations (typically computers) attached to the LANs operate as if they were attached to a single LAN for many purposes. Each bridge has a number of ports that attach, like stations, to the LANs. A bridge selectively forwards data frames received on any one of these ports to the others. An interconnected Bridged Local Area Network provides for an increase in the physical extent, the number of attached stations and the total performance of a LAN, and for the partitioning of physical LAN support for administration or maintenance. MAC Bridges are specified by IEEE Standard 802.1D (IEEE Std 802.1D-1998, IEEE Standards for Local and Metropolitan Area Networks: Media Access Control (MAC) Bridges) and its amendments including IEEE Standard 802.1w—Rapid Reconfiguration and IEEE Standard 802.1t.

When LAN segments and bridges are physically interconnected, it is possible to create loops in the network by providing more than one path between LAN segments. Since the service provided by the bridged local area network is intended to closely resemble the service provided by a single segment, and permits the attachment of stations to any segment, bridges may not add to or otherwise modify the data frames that they forward from one LAN segment to another to prevent loops. The IEEE 802.1D Standard specifies a distributed protocol that the bridges operate to maintain a fully connected (spanning) and loop-free (tree) active topology for the network. This protocol selects a Port Role for each Bridge Port. Ports with port roles of Root Port or Designated Port participate in the active topology by transmitting and receiving frames to and from the attached LAN segments, while Ports with port roles of Alternate Port or Backup Port do not.

To prevent temporary loops in the active topology, a bridge port with a Designated Port role discards frames for a period while transmitting spanning tree information in BPDUs (Bridge Protocol Data Units) to other bridges. After this period has elapsed the port assumes that all other Bridges in the network have received the relevant information and that it is safe to transition to Forwarding state. The IEEE 802.1w standard specified an improvement for rapid reconfiguration. On a point to point link a first Designated Port that is not forwarding transmits a proposal (a BPDU with the proposal flag set) to a first neighbor bridge. Said neighbor bridge responds with an agreement (a BPDU with the agreement flag set) if it agrees with said first port's spanning tree information. If the further neighbors of said first neighbor bridge are not already known to agree with said spanning tree information said first neighbor bridge transfers the temporary cut in the active topology to the Designated Ports connecting to said further neighbors and repeats the proposal and agreement handshake with said further neighbors.

Thus temporary cuts are introduced in the network to prevent loops but are moved rapidly to the edge of the network to facilitate rapid reconfiguration of the network as a whole. Bridge ports that do not connect to further bridges but directly to end stations such as personal computers that use the network are manually configured as edge ports. The protocol does not propagate cuts in the active topology to such edge ports.

If a bridge port does not connect by a point to point link to another bridge and the port is not manually configured as an edge port connectivity through the port is delayed by the timer specified by IEEE 802.1D resulting in a interruption in service of 30 seconds by default. This interruption interferes with a number of protocols typically used by personal computers. To avoid using manual configuration some equipment vendors identify bridge ports as edge ports by default. When these are connected together the resulting network loop though detected after a period can seriously impact network operation. It is therefore desirable to have an automatic method of rapidly and reliably determining that a port is an edge port before transitioning to the Forwarding state. Interruption of service on shared media LANs is not a significant problem at present as most bridged local area networks use point to point links except at their edges. However new LAN media are under constant development and it may prove advantageous to treat these as shared media.

The transition of a Designated Port to the Forwarding state following expiry of a timer rather than on receipt of an explicit agreement assumes that all other bridges attached to the LAN are capable of receiving BPDUs transmitted by the Designated Port and act upon them. Connectivity loops may occur despite the timer delay if a loop back has been inadvertently activated, if transmitting or receiving hardware has failed, or if a manual aggregation of links meant to connect two bridges has been misconfigured.

The calculation of spanning trees to provide full and loop-free connectivity in networks is not limited to bridged local area networks. Many protocols, such as those providing multicast for IP routers including OSPF (a common IP routing protocol) based multicast and DVMRP (Distance Vector Multicast Routing Protocol) calculate spanning trees to provide efficient distribution from one source to many destinations. The computation of spanning trees has been suggested to aid in the distribution of routing labels for MPLS (Multi Protocol Label Swapping) which is widely advocated to support growth of the Internet and IP related communications.

### BRIEF SUMMARY OF THE INVENTION

This invention comprises: a method for rapidly transitioning Designated Ports connected to shared media LANs to Forwarding state without loops in connectivity arising in a network of arbitrary physical topology; a method of rapidly and automatically detecting the edge of the network thus allowing the protocol mechanisms specified by IEEE Standard 802.1w-2001 to rapidly restore and or maintain connectivity to end stations attached at said network edge even when connectivity has to be temporarily suspended elsewhere in the network to prevent loops during network reconfiguration; a method of detecting accidental one way and loop back physical connectivity in a network and of preventing such connectivity from disrupting the service provided by the remainder of the network.

According to the invention, the Proposal/Agreement mechanism specified in IEEE Standard 802.1w-2001 and further described in IEEE Standard 802.1s, is extended to include setting of the proposal flag in BPDUs transmitted on shared media, introduction of temporary cuts in the topology by the receiving bridges, and the generation of BPDUs with the agreement flag set in response by said receiving bridges. The capture of all such responses to facilitate immediate rapid transition to Forwarding of a Designated Port first transmitting the proposal is theoretically possible, but not suggested on account of the difficulty and complexity of deciding when all other bridges attached to the shared media have responded. However the performance parameters and protocol message loss assumptions established by IEEE Standard 802.1w ensure that extended behavior of this invention permits transition to forwarding within twice the normal repetitive BPDU transmission interval, known as Hello Time, i.e. within a time that is independent of the overall network size and is purely a function of the implementation of the shared media LAN and directly attached bridges. Using the default timer values specified in IEEE Standard 802.1D and IEEE Standard 802.1w interruptions in connectivity are reduced from 30 seconds to 4 seconds. This avoids significantly interrupting the operation of many protocols.

Further, according to the invention, receipt of a rapid spanning tree BPDU with the learning flag set (set as specified in IEEE Standard 802.1w), causes a Designated Port that is transitioning to Forwarding to revert to the Discarding state, even if it is transmitting spanning tree information that is better than that contained in the received BPDU. This behavior ensures that loops are not created during periods of rapid reconfiguration when two bridge ports that are candidates for the Designated Port for a particular shared media LAN may each be receiving continually improving spanning tree information from the rest of the network. This behavior also prevents the formation of unwanted loops in the network in cases where the received BPDUs appear to come from a system that is unable to receive and defer to the better information transmitted by the first Designated Port. Such cases arise when a loop back has been inadvertently activated, when transmitting or receiving hardware has failed, or when a manual aggregation of links that are meant to connect two bridges have been misconfigured.

The generation of BPDUs in response to BPDUs transmitted with proposal flag on all media, according to the present invention, provides a method of ensuring that the presence of other bridges attached to the same LAN as a Designated Port is detected. Bridges implementing the legacy spanning tree protocol do not recognize the BPDUs transmitted by default by the rapid spanning tree protocol, so transmit their own BPDUs. Rapid spanning tree bridge ports that would otherwise defer to the BPDUs transmitted by a Designated Port transmit responses. The absence of other bridges attached to a particular bridge port can be ascertained within three seconds after enabling said port, to an acceptable level of reliability and with the use of default timer values.

Once a bridge port is known to be an edge port in a network, temporary cuts in topology introduced to prevent loops do not have to be propagated to said port.

Other aspects and advantages of the present invention can be seen upon review of the figures and the detailed description that follows.

### BRIEF DESCRIPTION OF THE SEVERAL VIEWS OF THE DRAWING

The Figures specify part of the operation of a bridge port implementing the rapid spanning tree protocol.

FIG. 1 specifies a state machine that handles the reception of BPDUs. Each time a BPDU is received (as indicated by the rcvdBpdu variable becoming TRUE) the RECEIVED state is entered. One of the actions specified in said RECEIVED state is the setting of the variable operEdge false to indicate that the port is not at the edge of the bridged network.

FIG. 2 specifies the protocol information state machine that holds spanning tree information for the port and acts upon a newly received spanning tree message. If the information in said message is worse than that currently held for the port and the learning flag is set in the received BPDU it sets a variable called disputed (using the recordDispute( ) procedure in the INFERIOR_DESIGNATED state).

FIG. 3 specifies the part of the protocol role transition state machine that transitions a Designated Port to the forwarding state. If the variable disputed is set the port is instructed to stop forwarding frames (DESIGNATED_LISTEN). If the port does become forwarding it is now known that the spanning tree information is in agreement with neighboring bridges (DESIGNATED_FORWARD).

FIG. 4 specifies a Bridge Detection machine used to set operEdge true or false depending on the setting of administrative and operational protocol variables. The present invention introduces the autoEdge parameter allowing the bridge port to automatically set operEdge true if the time edgeDelayWhile expires while the bridge port has been transmitting rapid spanning tree BPDUs with the proposal flag set.

### DETAILED DESCRIPTION OF THE INVENTION

A detailed description of the present invention is provided with reference to the figures.

The figures specify four state machines that are part of the operation of a bridge port implementing the rapid spanning tree protocol specified by IEEE Std 802.1w-2001 as amended by the present invention and other modifications proposed by the present inventor using the state machine conventions and notation specified in IEEE Std 802.1w pages 45 and 46 and familiar to those skilled in the art. Except as otherwise described the protocol variables are as described in IEEE Std 802.1w-2001 and IEEE Std 802.1t-2001 amended by the present invention.

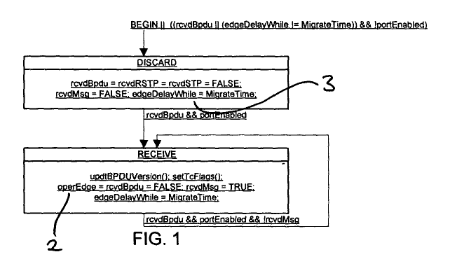

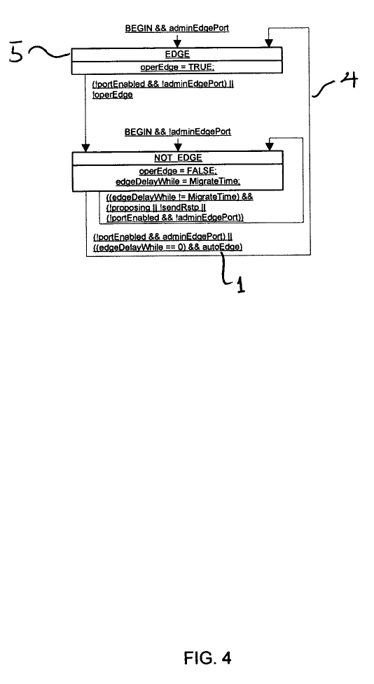

The operEdge variable indicates that the bridge port is not connected to any other bridge port. If the autoEdge variable 1 in FIG. 4, according to this invention, is true then operEdge will be determined automatically and rapidly as compared to prior art. The variable operEdge 2 is set false after each control message (known as a BPDU) is received, as specified by the state machine in FIG. 1. A timer edgeDelayWhile 3 is set to run for a time MigrateTime in FIG. 1. If the timer expires operEdge will be set true as specified by the transition 4 to the EDGE state 5 in FIG. 4.

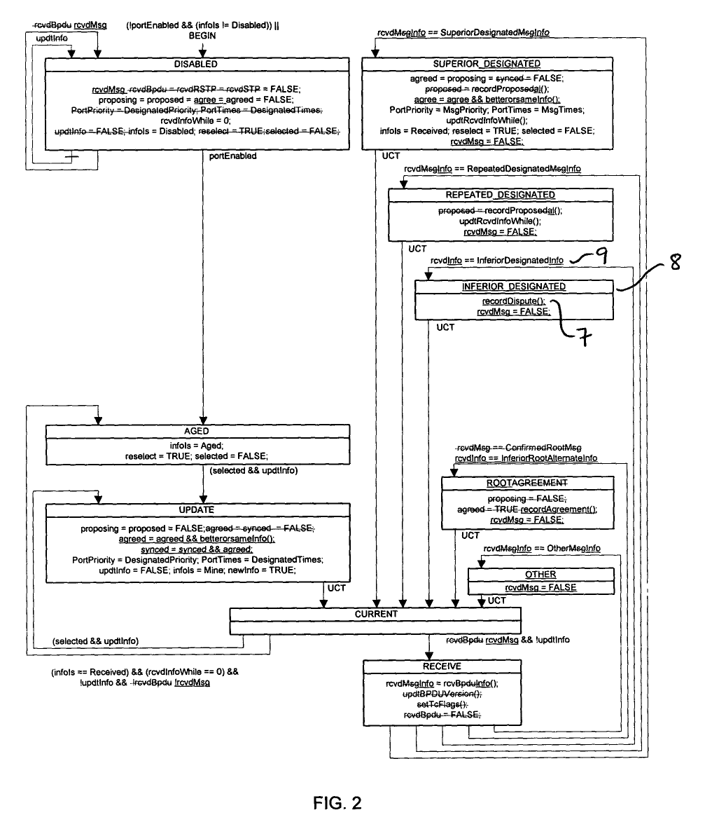

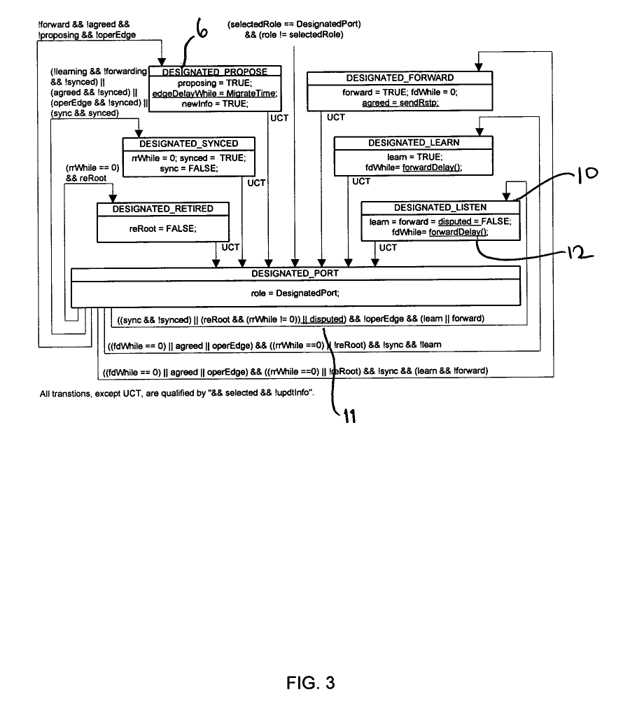

According to the invention the Proposal flag specified in IEEE Std 802.1w-2001 is set in the DESIGNATED_PROPOSE state 6 shown in FIG. 3 for transmission by a first bridge port in a first BPDU and acted on upon receipt even if the receiving bridge port is attached to shared media. Said receiving bridge port will respond with a second BPDU of its own either disagreeing or agreeing with the information in the received first BPDU. Thus the first port will receive a BPDU and will rapidly update the state of the operEdge variable. If said receiving port sends said second BPDU in disagreement 9 with said first port and the Learning flag is set in that second BPDU said first port will invoke the recordDispute( ) procedure 7 in the INFERIOR_DESIGNATED state 8 in FIG. 2 to set the disputed variable and transition to the DESIGNATED_LISTEN state 10 in FIG. 3 to cease or inhibit forwarding of frames as required by the condition 11. If the network device comprising said receiving port agrees with the first BPDU it will transition other Forwarding ports to the DESIGNATED_LISTEN state 10. Thus said first port need only wait for said receiving port to receive and act upon said first BPDU and the time forwardDelay( ) 12 in FIG. 3 is reduced by the present invention.

The present invention is not limited to the field of Bridged Local Area Networks and may be applied whenever distributed loop free active topology, i.e. spanning tree, calculation is desired.

The foregoing description of preferred embodiments of the invention has been presented for the purposes of illustration and description. The description is not intended to be exhaustive or to limit the invention to the precise forms disclosed. Many modifications and variations will be apparent to practitioners skilled in this art.

I claim:

1. For a network comprising a plurality of communication links connected by a plurality of network devices said network being capable of transmitting frames of data, a network device comprising:
a plurality of ports coupled to communication links in the network;
topology management resources which manage the plurality of ports to select an active topology that is loop-free by forwarding, that is transmitting and or receiving, frames through one or more ports in the plurality of ports and not forwarding frames through the zero or more other ports in the plurality of ports;
additional logic for a first port of said network device that transmits a control message through said first port to other ports of other network devices said other ports being attached to the same media as said first port said message instructing each said other network device to ensure the topology is loop-free by ceasing to transmit frames of data through ports in the plurality of ports composing said other network device within a certain time or to transmit a control message of disagreement to said first port within a certain time said additional logic causing said first port to transmit and receive frames after a certain time has elapsed if no control message of disagreement has been received;
additional logic for said network device that receives a first control message on a first port instructing said network device to ensure the topology is loop-free and acts within a certain time to cease transmitting frames other than control messages through said first port or to cease transmitting frames other than control messages through other ports or to transmit a control message of disagreement with said first control message.

2. The network device of claim 1, wherein the additional logic is used for a first port if the media attached to said first port is capable of connecting to two or more other ports of network devices.

3. The network device of claim 1, wherein the control messages transmitted and received by the network device comprise information for the purpose of selecting a loop-free active topology specified in IEEE Std 802.1D-1998 or in IEEE Std 802.1w-2001 or in IEEE Std 802.1s-2002 or in a specification derived from or compatible with or interoperable with one or more of those standards.

4. The network device of claim 2, wherein the control messages transmitted and received by the network device comprise information for the purpose of selecting a loop-free active topology specified in IEEE Std 802.1D-1998 or in IEEE Std 802.1w-2001 or in IEEE Std 802.1s-2002 or in a specification derived from or compatible with or interoperable with one or more of those standards.

5. For a network comprising a plurality of communication links connected by a plurality of network devices said network being capable of transmitting frames of data, a network device comprising:
a plurality of ports coupled to communication links in the network;
topology management resources which manage the plurality of ports to select an active topology that is loop-free by forwarding, that is transmitting and or receiving, frames of data through one or more ports in the plurality of ports and not forwarding frames through the zero or more other ports in the plurality of ports;
logic for a first port of said network device that determines that said first port is attached to a medium that is not attached to any other port of any other device that is intended to form part of the loop-free active topology by transmitting a first control message through said first port that ensures that other ports of other network devices receiving said first control messages will transmit control messages within a certain time the logic of said first port concluding that no other ports is attached to the medium unless it receives control messages from one or more other ports within a certain time;
additional logic for said network device that receives a first control message on a first port for ensuring a port other than the port transmitting said first control message will transmit a second control message within a certain time.

6. The network device of claim 5, wherein the control messages transmitted and received by the network device comprise information for the purpose of selecting a loop-free active topology specified in IEEE Std 802.1D-1998 or in IEEE Std 802.1w-2001 or in IEEE Std 802.1s-2002 or in a specification derived from or compatible with or interoperable with one or more of those standards.

7. For a network comprising a plurality of communication links connected by a plurality of network devices said network being capable of transmitting frames of data, a network device comprising:
a plurality of ports coupled to communication links in the network;
topology management resources which manage the plurality of ports to select an active topology that is loop-free by forwarding, that is transmitting and or receiving, frames of data through one or more ports in the plurality of ports and not forwarding frames through the zero or more other ports in the plurality of ports;
additional logic for a first port of said network device attached to a first medium that guards against the creation of a loop in the active topology as a result of a port attached to said first medium not receiving or acting upon control messages transmitted by said first port said additional logic causing said first port not to transmit or receive frames of data if information received in a control message indicates that a port is not taking into account control messages transmitted by said first port and is proposing to forward frames to and from said first medium.

8. The network device of claim 7, wherein the control messages transmitted and received by the network device comprise information for the purpose of selecting a loop-free active topology specified in IEEE Std 802.1D-1998 or in IEEE Std 802.1w-2001 or in IEEE Std 802.1s-2002 or in a specification derived from or compatible with or interoperable with one or more of those standards.
